(19) United States
(12) Patent Application Publication
(10) Pub. No.: US 2011/0186001 A1
(43) Pub. Date: Aug. 4, 2011

(54) Modifying an Internal Combustion Engine for Radical Ignition Combustion

(75) Inventors: William Paul McCowan, Queenstown, MD (US); John Spence Hayes Chapman, JR., White Hall, MD (US)

(73) Assignee: Total Energy Renewable Power System (TERPS), LLC, Annapolis, MD (US)

(21) Appl. No.: 12/699,341

(22) Filed: Feb. 3, 2010

(51) Int. Cl. F02F 1/00; B23P 6/00; F02F 7/00

(52) U.S. Cl. 123/193.2; 29/888.011; 123/195 R

(57) ABSTRACT

Methods and apparatus for modifying an internal combustion engine for radical ignition combustion to aid in ignition and enhance combustion. In one embodiment, the present invention includes a method of modifying an internal combustion engine with at least one cylinder to control the production and flow of radical ignition species for enhanced combustion comprising the steps of: adding a cylinder spacer plate with at least one opening, wherein each opening corresponds to each cylinder in an engine block of the internal combustion engine; adding at least one radical production member for providing and storing radical ignition species, wherein each member is disposed inside of each opening in the spacer plate and have at least one opening to fluidly connect each member to each cylinder; and attaching the spacer plate to the engine block, wherein the plate is disposed so as to be sandwiched between the engine block and a cylinder head of the internal combustion engine.

### BACKGROUND OF THE INVENTION

1. Field of the Invention

The filed of the present invention relates to internal combustion engines.

2. Background Art

The internal combustion (IC) engine has long been a source for power, especially for transportation and stationary power. Improved control over the ignition and combustion efficiencies in an IC engine has been a long sought goal.

In conventional spark ignition (SI) engines and conventional compression ignition (CI) engines, the ignition process is driven by relatively high temperature chemical-kinetics mechanisms requiring relatively high levels of heat to start combustion. Also, for combustion initiated by SI and CI modes to be sustained, relatively higher concentrations of fuel relative to oxygen are typically required.

In more recent developments in the field of combustion technology and science, the importance of chemical activity leading up to the oxidation reaction of fuel substances as well as the physical environment needed for dependable spontaneous ignition, have led to research regarding the role of radical species of hydrocarbon fuels in the process of ignition and combustion of fuels in SI and CI internal combustion engines. In contrast to conventional SI and CI, radical ignition (RI) combustion can enable a reduction of the heat and/or compression ratio required for ignition and a reduction in the ratio of fuel and oxygen required for sustaining combustion.

Radical ignition combustion arises from the recognition that controlled seeding of a fuel charge before ignition in a SI or CI engine with highly active radical species of fuel generated in a cool flame process can produce dependable and predictable ignition and combustion. RI combustion involves the production of radical species during one combustion cycle and storing for discharge in a succeeding combustion cycle. During each combustion cycle, a portion of the fuel oxygen mixture is contained in a secondary chamber and undergoes a cool flame oxidation reaction to produce radical species that are discharged during a succeeding combustion cycle for seeding the next fuel-oxygen mixture charge released into the main combustion chamber. The process results in enhanced combustion by reducing the temperature or compression needed for ignition.

### BRIEF SUMMARY OF THE INVENTION

In embodiments, the present invention modifies a conventional internal combustion engine for radical species ignition. In one embodiment, the present invention includes a method of modifying a internal combustion engine with at least one cylinder to control the production and flow of radical ignition species for enhanced combustion comprising the steps of: adding at least one removable radical production member for providing and storing radical ignition species, wherein the at least one production member is disposed inside of an opening in a cylinder spacer plate and has at least one opening or vent to fluidly connect each production member to a corresponding cylinder in an engine block; and attaching the cylinder spacer plate to the engine block, wherein the spacer plate is disposed so as to be between the engine block and a cylinder head of the internal combustion engine such that the opening or openings in the spacer plate correspond to the cylinder or cylinders of the internal combustion engine and each production member fluidly communicates with a main combustion chamber defined by each cylinder.

In an alternative embodiment of the present invention, the method of modifying a internal combustion engine with at least one cylinder to control the production and flow of radical ignition species for enhanced combustion comprises the steps of: creating at least one annular channel in a top surface of an cylinder block around the circumference of at least one opening defining at least one cylinder; adding at least one radical production member for providing and storing radical ignition species, wherein each production member is disposed inside of the at least one annular channel and have at least one opening to fluidly connect each of production member to each cylinder; and assembling the engine block, at least one radical production member and a cylinder head to form a modified IC engine in accordance with an embodiment of the present invention.

Another embodiment of the present invention relates to a modified internal combustion engine comprising: a cylinder head; an cylinder block containing a plurality of cylinders and a plurality of pistons, wherein the cylinders, the pistons and the cylinder head define a plurality of main combustion chambers; a cylinder spacer plate; and a plurality of radical production members. The spacer plate includes a plurality of openings corresponding to the plurality of cylinders in the cylinder block. The spacer plate is disposed so as to be between the cylinder block and the cylinder head and attached to the engine block via a plurality of head bolts. The radical production members are provided for producing and storing radical ignition species. The production members are disposed within the openings in the spacer plate and include at least one reaction opening to fluidly connect the production members with the main combustion chambers.

Further embodiments, features, and advantages of the present invention, as well as the structure and operation of the various embodiments of the present invention, are described in detail below with reference to the accompanying drawings.

It is to be understood that both the foregoing general description and the following detailed description are exemplary and explanatory only, and are not restrictive of the invention as claimed.

### BRIEF DESCRIPTION OF THE DRAWINGS/FIGURES

The accompanying figures, which are incorporated herein and form part of the specification, illustrate a cylinder assembly for a modified IC engine. Together with the description, the figures further serve to explain the principles of the a modified IC engine described herein and thereby enable a person skilled in the pertinent art to make and use the modified IC engine.

FIG. 1 is a cross sectional view of an exemplary cylinder assembly made according to an embodiment of the present invention.

FIG. 2 is a plan view of an exemplary multi-cylinder spacer plate made according to an embodiment of the present invention.

FIG. 3 is a perspective view of an exemplary radical production member made according to an embodiment of the present invention.

FIG. 4 is a cross sectional view of an exemplary cylinder assembly made according to another embodiment of the present invention.

FIG. 5 is a cross sectional view of an exemplary cylinder assembly made according to another embodiment of the present invention.

### DETAILED DESCRIPTION OF THE INVENTION

Reference will now be made in detail to embodiments of the present invention with reference to the accompanying figures, in which like reference numerals indicate like elements.

Embodiments of the present invention relate to methods and apparatus for modifying a conventional internal combustion engine for radical species ignition for enhanced ignition and combustion.

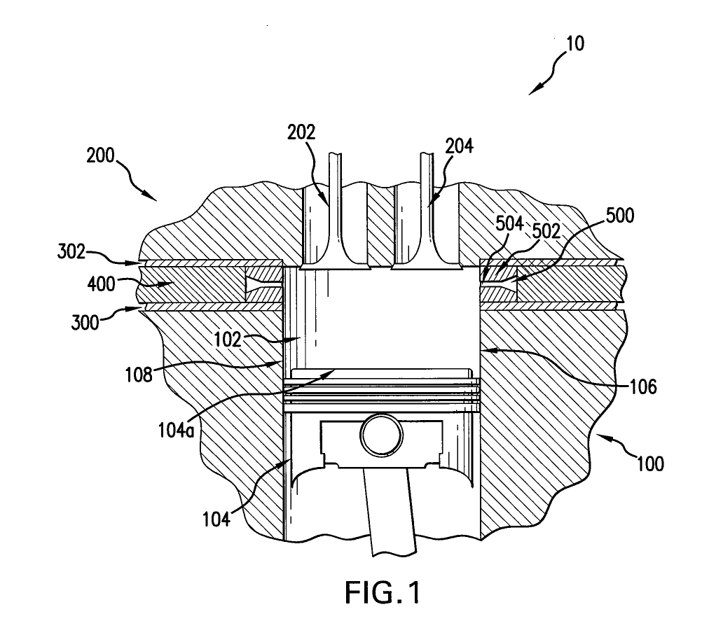

FIG. 1 is a diagram showing a cross-sectional view of an exemplary cylinder assembly 10. Cylinder assembly 10 can be part of a modified internal combustion engine (not shown) made according to an embodiment of the present invention. In one embodiment, cylinder assembly 10 can be incorporated into a single cylinder modified internal combustion engine. In other embodiments, a plurality of exemplary cylinder assembly 10 can be incorporated into a multi-cylinder modified internal combustion engine. For example, a plurality of cylinder assembly 10 can be incorporated into a 2-cylinder IC engine, a 4-cylinder IC engine, a 6-cylinder IC engine, an 8-cylinder IC engine or any other known multi-cylinder configuration of an IC engine known to one of skill in the art to modify an IC engine according to an embodiment of the present invention.

Cylinder assembly 10 includes an engine or cylinder block 100, cylinder head 200, first and second head gaskets 300 and 302, cylinder spacer plate 400, and radical production members 500. Engine block 100 includes main combustion chamber 102, piston 104, and cylinder wall 106. Cylinder head 200 includes intake valve 202 and outtake valve 204. Radical production members 500 include grooves 502 and opening 504. Engine block 100, first head gasket 300, cylinder spacer plate 400, second head gasket 302, and cylinder head 200 are attached and secured via head bolts (not shown) to form cylinder assembly 10 of an IC engine modified according to an embodiment of the present invention. Cylinder spacer plate 400, disposed between engine block 100 and cylinder head 200, creates a volume of space for inserting radical production members 500 into cylinder assembly 10. Radical production members 500 are for producing and storing radical ignition species for conversion of a conventional IC engine to a radical ignition engine for enhanced combustion.

As illustrated in FIGS. 1-3, a conventional IC engine is easily adapted for radical ignition by modifying cylinder assembly 10 to include radical production members 500 for producing and storing radical ignition species. Because the present invention does not require modification of the piston(s) 104 or the cylinder head 200 of the IC engine, any conventional off-the-shelf IC engine, such as a diesel engine, gasoline engine, 4-stroke or 2-stroke multi-cylinder IC engine, and the like may be modified according to the present invention for radical ignition. Furthermore, because engine 10 is modified by the addition of radical production members 500 adjacent to main combustion chambers 102 in cylinder block or engine block 100, engine 10 can be easily adapted for use with multiple fuel types. For example, a diesel IC engine can be readily adapted for use with alcohol based fuels with minimal further modification of engine 10.

In one embodiment of the present invention, a method of modifying an IC engine comprises the steps of adding a cylinder spacer plate with a plurality of openings to the IC engine, wherein the openings correspond to a plurality of cylinders in an engine block of the multi-cylinder internal combustion engine; adding a plurality of radical production members for providing and storing radical ignition species, wherein the production members are disposed inside of the openings in the cylinder spacer plate and have at least one opening or vent to fluidly connect each of the production members to each of the plurality of cylinders; and attaching the cylinder spacer plate to the engine block, wherein the spacer plate is disposed so as to be between the engine block and a cylinder head of the internal combustion engine.

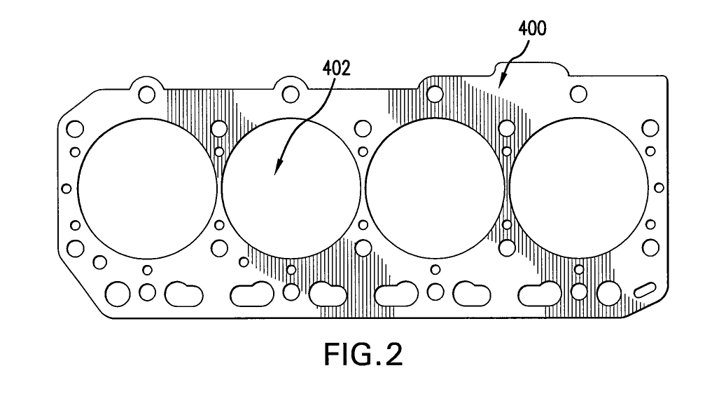

The step of adding may involve creating cylinder spacer plate 400 to be a mirror image in shape of a head gasket 300 such that the openings 402 of spacer plate correspond in location to the main combustion chambers 102 in engine block 100, as shown in FIG. 2. Main combustion chambers 102 are defined by a top surface 104a of piston 104, the inner wall 106a of cylinder 106 and cylinder head 200. Openings 402 should be of a sufficient diameter for securely housing radical production members 500. Also, spacer plate 400 should be of a sufficient thickness to create a volume of space, between engine block 100 and cylinder head 200, in which radical production members 500 may be disposed so a top surface 500a and a bottom surface 500b of production members 500 are flush or substantially even with a top surface and a bottom surface of spacer plate 400. The thickness of spacer plate 400 will depend on the size of radical production members 500 which is dependent on the fuel type used for engine 10. For example, the thickness of production members 500, and likewise the thickness of spacer plate 400, should be sufficient to create a volume of void space for storing radical species ranging from one twentieth ( 1/20) to one quarter (¼) of the volume of combustion chamber 102 when piston 104 is at top-dead-center.

Also, by mirroring the shape of head gasket 300, a set of head bolts for securing head gasket 300 to engine block 100 can be utilized for attaching spacer plate 400 as well to the engine block without having to alter the engine block, head gasket, and cylinder head for securing spacer plate 400.

Cylinder spacer plate 400 can be made through any conventional metal manufacturing process. For example, spacer plate 400 may be manufactured through a Computer Numeric Control (CNC) machining process. In other embodiments, the spacer plate may be created via conventional milling processes or any other suitable machining process for precision machining of metal materials known to one of ordinary skill in the art.

Spacer plate 400 can be manufactured from aluminum or steel. Other examples of materials that may be used for creating spacer plate 400 include iron, titanium, ceramics, or any other suitable material that is capable of maintaining the proper temperature range for the production and storage of radical species known to one of ordinary skill in the art.

Spacer plate 400 may be attached to engine block 100 via conventional head bolts. Because spacer plate 400 corresponds in shape to head gasket 300, it is not necessary to alter the engine block for attaching spacer plate. Spacer plate 400 should be disposed above engine block 100 and above a first head gasket 300 and secured via head bolts. Generally, the existing head bolts for engine 10 can be used, however, in some embodiments, it may be necessary to replace the existing head bolts with a second set of head bolts longer in length so as to accommodate the thickness of space plate 400.

The method comprises adding a plurality of radical production members 500 for producing and storing radical ignition species. Production members 500 serve as origination sites for the generation of a plurality of radical ignition species during a combustion cycle of the engine and allow for storage of radical species for release during succeeding combustion cycles.

Radical production members 500 can be made via any suitable metal or ceramic manufacturing process. For example, in one embodiment, production members 500 may be created through a Computer Numeric Control (CNC) machining process. In other embodiments, the production, members may be created via conventional milling or turning processes or any other suitable machining process for precision machining of metal materials known to one of ordinary skill in the art. In some embodiments, the production members can be created from ceramic materials via ceramic manufacturing processes such as, for example, casting, extrusion, or any other suitable method known to one of skill in the art.

Production members 500 can be made from any suitable metal or ceramic material that can tolerate the heat of combustion for the selected fuel type to be used in the modified IC engine. In some embodiments, the material used for creating production members 500 should be suitable for tolerating heat transfer rates ranging from 5 BTU/lbs-hr to 100 BTU/lbs-hr depending on the selected fuel source. For example, in one embodiment for modifying a diesel or other heavy fuel engine, production members 500 may be made from steel or any other suitable material know to one of ordinary skill in the art having a heat transfer rate ranging from about 5 BTU/lbs-hr to 30 BTU/lbs-hr. Alternatively, production members 500 may be made from iron, nodular iron or any other suitable material know to one of ordinary skill in the art having a heat transfer rate ranging from about 15 BTU/lbs-hr to 25 BTU/lbs-hr for use with ethanol, methanol, or other alcohol based fuel sources.

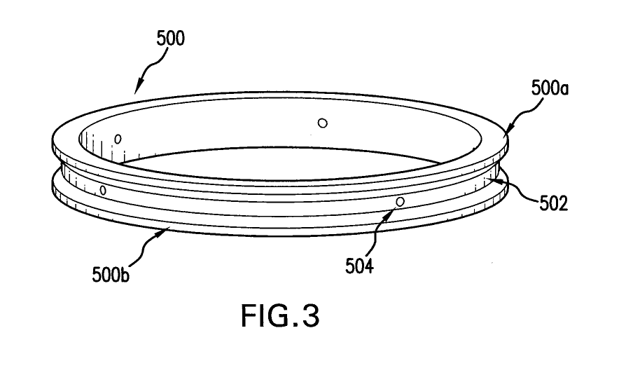

As shown in FIG. 3, radical production members 500 are substantially circular rings that are similar in diameter to the diameter of the main combustion chambers 102 in engine block 100. Production members 500 may have grooves or channels 502 formed in the outer circumferential surface of production members 500 to create a volume of space for producing and storing radical ignition species. In one embodiment, groove 502 formed in a production member 500 can be a single continuous channel spanning the complete outer circumferential surface. In other embodiments, groove 502 can be segmented in the outer circumferential surface of production member 500

Also, production members 500 have a plurality of openings or vents 504 so as to fluidly connect production members 500 with main combustion chambers 102 in engine block 100 to allow the flow of a plurality of radical ignition species into main combustion chambers 102. The openings 504 are of sufficient size to allow sufficient mass transfer of radical species for radical ignition. However, the size of the openings should be sufficiently small to prevent the flame front from entering the openings and consume the radical species in the production members. The size of the openings will depend on the type of fuel being used in the IC engine but will typically be in the range of 1 to 1.5 mm in diameter.

Production members 500 are disposed in openings 402 within spacer plate 400 so at to be fluidly connected with combustion chambers 102. In one example, production members 500 are removeably attached to spacer plate 400 and held securely in openings 402 due to tension caused by the small size difference between the diameter of the openings 402 and outer diameter of members 500. Because production members 500 are removably secured to openings 402, in one embodiment, members 500 can be removed and replaced with a second set of production made from a different material for use with a different fuel type. For example, a first set of members made from steel for use with diesel fuel can be easily replaced with a second set of members made from iron for use with an alcohol based fuel type.

Once spacer plate 400 and production members 500 are manufactured, they may be attached to engine block 100 to modify a conventional IC engine to a radical ignition combustion engine. To assemble the modified IC engine in one embodiment, a first head gasket 300 is disposed on top of engine block 100, then spacer plate 400 is disposed on top of first head gasket 300 and production members 500 are disposed within openings 402 of the spacer plate. Then a second head gasket 302 is disposed above spacer plate 400 and production members 500 so that spacer plate 400 and members 500 are sandwiched between first and second head gasket 300 and 302. First and second head gaskets 300 and 302 are sandwiched between engine block 100 and cylinder head 200 to create a cylinder assembly for the modified IC engine. By using head gaskets 300 and 302 above and below spacer plate 400 and production members 500, a fluid seal is created at the joints between spacer plate 400 and production members 500 and it is unnecessary to permanently seal the joints. Creating a fluid seal prevents radical species from escaping production members and preserves radical species for use during the combustion cycle in the main combustion chambers.

In other embodiments, a fuel control system may be added to the modified IC engine to control the flow of the fuel and radical species to main combustion chamber. Conventional, off the shelf, control devices may be modified to control the fuel flow of a modified IC engine for radical combustion. For example, computer management systems, which include fuel injector controls, carburetor controls, ignitions controls, and other standard control systems may be modified for optimization of the radical combustion in the modified IC engine

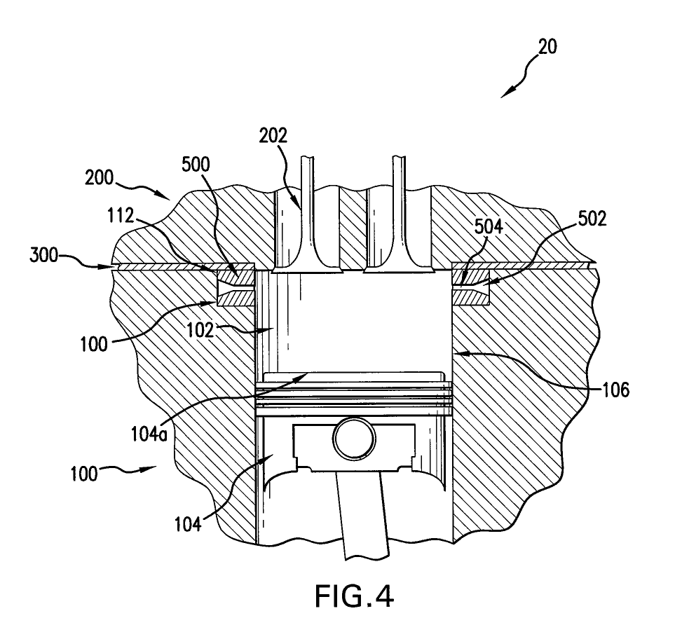

In another embodiment, as shown in FIG. 4, a spacer plate is not necessary to create a volume of space for housing production members 500. Rather, a volume of space for containing production members is created directly in engine block 100. Circular channels 110 are formed in engine block 100 around the perimeter of combustion chambers 102. Channels 110 are of sufficient diameter and depth to accommodate the largest diameter of and thickness of production members 500 such that when the production members are disposed within channels 110 the upper surfaces of the production members are flush or even with the upper surface of engine block 100. Production members 500 are be disposed in channels 110 so as to be fluidly connected to main combustion chambers 102 to prevent radical species from escaping production members 500. Because the production members are disposed within engine block 100, only a first head gasket is needed to create a fluid seal at the joint 112 between engine block 100 and production members 500.

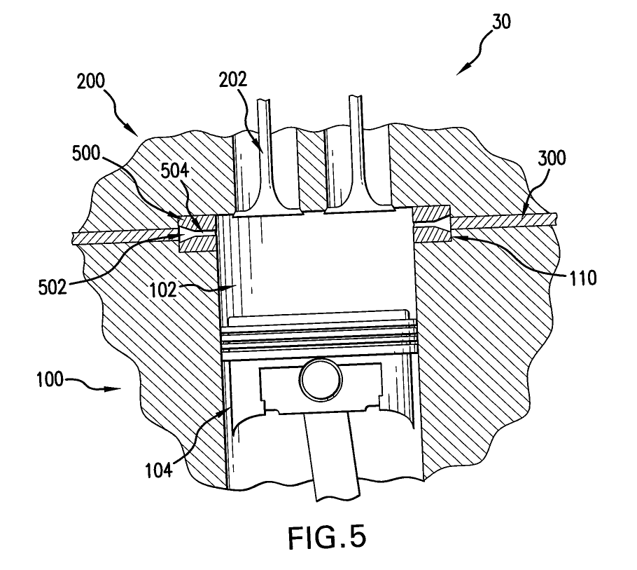

In another embodiment, as shown in FIG. 5, channels 110 for housing production members 500 may be created in both engine block 100 and cylinder head 200 so as to create a sufficient void space for accommodating production members 500. Circular channels 110 are formed in engine block 100 around the perimeter of combustion chambers 102 and in cylinder head 200 so as to correspond to the channels in engine block 100. Channels 110 in engine block 100 are of sufficient diameter and depth to accommodate the largest diameter and a portion of the thickness of production members so that, when members are disposed within channels 110 of engine block 100 and of cylinder head 200, engine block 100 and cylinder head 200 can be secured together without a gap or void space between the engine block and cylinder head. Production members 500 are be disposed in channels 110 so as to be fluidly connected to main combustion chambers 102.

To assemble a modified IC engine in accordance with this embodiment of the present invention, production members 500 are disposed within channels 110 in the engine block, a head gasket 300 is disposed on above a top surface of engine block 100, and cylinder head 200 is disposed above a head gasket 300 so that the channels in cylinder head align with production members 500 and house the remaining thickness of production members which is extended above the top surface of engine block 100.

Engine block 100 includes a plurality of pistons 104, slidably disposed in cylinders 106 and main combustion chambers 102 are defined by an upper surface of piston 104a, the inner wall 108 of cylinders 106 and cylinder head 200. Cylinder head 200 preferably includes a plurality of intake valves 202 and exhaust values 204 that are in communication with main combustion chamber 102. Additionally, cylinder head 200 may include an intake manifold, outtake manifold, and spark plugs, not shown.

In operation of a modified engine made in accordance with an embodiment of the present invention, radical species produced during a combustion cycle of the modified IC engine to assist ignition and enhance combustion. At the start of a combustion cycle, the radical species in production members 500 are generally in a state of equilibrium. As the combustion cycle processes, naturally occurring pressure differences between production members 500 and main combustion chambers 102 cause some of the radical species in each production chamber to transfer to main chambers 102 through openings 502 in production members 500. The radical species “seed” the fuel charge in main chambers 102 for radical ignition to enhance combustion. The combustion of the modified IC engine may be enhanced by optimizing the radical combustion. To optimize the radical combustion of the modified IC engine, the compression ratio for the modified IC engine may be altered. Optimization of the radical combustion in the modified IC engine can also improve the fuel economy and/or emissions of the modified IC engine in comparison to a corresponding un-altered IC engine.

While various embodiments of the present invention have been described above, it should be understood that they have been presented by way of example only, and not limitation. It will be apparent to persons skilled in the relevant art that various changes in form and detail can be made therein without departing from the spirit and scope of the present invention. Thus, the breadth and scope of the present invention should not be limited by any of the above-described exemplary embodiments, but should be defined only in accordance with the following claims and their equivalents. All patents and publications discussed herein are incorporated in their entirety by reference thereto.

What is claimed is:

1. A method of modifying an internal combustion engine with at least one cylinder to control the production and flow of radical ignition species for enhanced combustion comprising the steps of:
(a) adding at least one removable radical production member for providing and storing radical ignition species to a cylinder spacer plate, wherein said cylinder spacer plate has a at least one opening and said at least one production member is disposed inside of said at least one opening in said cylinder spacer plate and has at least one vent to fluidly connect each of said at least one production member to each of at least one cylinder in an engine block; and
(b) attaching said spacer plate and added at least one production member to said engine block, wherein said spacer plate is disposed between said engine block and a cylinder head of said internal combustion engine, such that said at least one opening corresponds to said at least one cylinder in an engine block, and each of said at least one production member fluidly connect to a corresponding main combustion chamber, wherein said at least one cylinder defines said corresponding main combustion chamber.

2. The method of claim 1 wherein said attaching step further comprising disposing said spacer plate between a first head gasket and a second head gasket, wherein said first and second head gaskets are disposed between said engine block and said cylinder head of said internal combustion engine, wherein an assembly of said engine block, said first head gasket, said spacer plate, said second head gasket, and said cylinder head is secured via a set of head bolts.

3. The method of claim 1 further comprising manufacturing said cylinder spacer plate and said at least one production member.

4. The method of claim 1 wherein said at least one radical production member is a circular ring, wherein the ring is removably affixed to said at least one opening in said cylinder spacer plate.

5. The method of claim 4 wherein said at least one production member further comprises at least one groove in an outer circumferential surface of said at least one production member for storing a volume of radical ignition species.

6. The method of claim 5 wherein said at least one groove has a volume of space ranging from one-twentieth to one-quarter the volume of said main combustion chamber when a piston is at top-dead center.

7. The method of claim 1 wherein said at least one radical production member is made of steel for use with a heavy fuel source.

8. The method of claim 1 wherein said at least one radical production member is made of an iron compound for use with an alcohol based fuel source.

9. The method of claim 1 further comprising the steps of:
replacing said at least one production member with at least one production member made of a different material to be used with a different fuel source.

10. A method of modifying internal combustion engine with at least one cylinder to control the production and flow of radical ignition species for enhanced combustion comprises the steps of:
(a) forming at least one annular channel in a top surface of a cylinder block around the circumference of at least one opening defining at least one cylinder in said cylinder block;
(b) adding at least one radical production member for providing and storing radical ignition species, wherein said at least one production member is disposed inside of said at least one annular channel and has at least one opening to fluidly connect each of said at least one production member to each of said at least one cylinder; and
(c) assembling said engine block, said at least one radical production member and a cylinder head.

11. The method of claim 10 wherein said at least one annular channel is of a depth substantially equal to the thickness of said at least one production member so said at least one production member is substantially disposed within said annular channels.

12. The method of claim 10 wherein at least one production member further comprises at least one groove in an outer circumferential surface of said at least one production member for storing a volume of radical ignition species; wherein said at least one groove has a volume of space ranging from approximately one-twentieth to one-quarter the volume of said main combustion chamber when a piston is at top-dead-center to enable radical species ignition in said modified IC engine.

13. The method of claim 10 further comprising the step of: creating at least one annular channel in a bottom surface of a cylinder head so as to correspond in location to said at least one annular channel in said engine block; wherein said at least one annular channel of said engine block are of a depth so only a portion of the thickness of said at least one production member is disposed within said at least one annular channel of said engine block; and wherein said at least one annular channel of said cylinder head is of a sufficient depth so a remaining portion of said at least one production member is disposed within said at least one annular channels of said cylinder head.

14. A modified internal combustion engine comprising:
a cylinder head;
an engine block containing a plurality of cylinders and a plurality of pistons; wherein a plurality of main combustion chambers are defined by said cylinders, said pistons, and said cylinder head;
a cylinder spacer plate, wherein said spacer plate includes a plurality of openings corresponding to said plurality of cylinders in said cylinder block;
a plurality of production members, wherein said production members are disposed within said openings in said spacer plate and include at least one vent to fluidly connect said production members with said main combustion chambers; and
wherein said spacer plate is disposed between said engine block and said cylinder head and attached to said engine block via a plurality of head bolts.

15. The modified internal combustion engine of claim 14 further comprising: at least one head gasket wherein said at least one head gasket is disposed between said engine block and said spacer plate so as to provide a seal between said openings in said spacer plate and said plurality of production members.

16. The modified internal combustion engine of claim 14 wherein said radical production members are circular rings, wherein the rings are removably affixed to said openings in said cylinder spacer plate.

17. The modified internal combustion engine of claim 14 wherein said production members further comprise a groove in an outer circumferential surface of said production members for storing a volume of radical ignition species.

18. The modified internal combustion engine of claim 17 wherein said grooves have a volume of space ranging from approximately one-twentieth to one-quarter the volume of said main combustion chamber when said piston is at top-dead center.

19. The modified internal combustion engine of claim 14 wherein said radical production members are made of steel for use with a heavy fuel source.

20. The modified internal combustion engine of claim 14 wherein said radical production members are made of iron compounds for use with an alcohol based fuel source.

21. An apparatus comprising:
a cylinder spacer plate, wherein said spacer plate includes a plurality of openings corresponding to a plurality of cylinders in a cylinder block; and
a plurality of production members, wherein said production members are disposed within said openings in said spacer plate and include at least one vent to fluidly connect said production members with a plurality of main combustion chambers defined by said cylinders.
